(19) United States
(12) Patent Application Publication
(10) Pub. No.: US 2026/0155322 A1
(43) Pub. Date: Jun. 4, 2026

(54) KEY STRUCTURE

(71) Applicant: LITE-ON TECHNOLOGY CORPORATION, Taipei (TW)

(72) Inventor: Ko-Hsiang LIN, Taipei (TW)

(21) Appl. No.: 19/035,309

(22) Filed: Jan. 23, 2025

(30) Foreign Application Priority Data
Dec. 4, 2024 (CN) 202411771038.9

(51) Int. Cl. H01H 13/02; G06F 3/01; G06F 3/02; G06F 3/044

(52) U.S. Cl. CPC H01H 13/023; G06F 3/021; G06F 3/044; G06F 3/016; H01H 2215/052; H01H 2219/056; H01H 2219/06; H01H 2219/062

(57) ABSTRACT

A key structure is provided. The key structure comprises a circuit board, at least one light-emitting unit, a light guide plate and a keycap. The circuit board has a touch-sensing circuit. The at least one light-emitting unit is electrically connected to the circuit board and positioned above the circuit board. The light guide plate is positioned adjacent to the at least one light-emitting unit and above the circuit board. The keycap is positioned above the at least one light-emitting unit, the light guide plate, and the circuit board.

This application claims the benefits of the People's Republic of China application Serial No. 202411771038.9 filed on Dec. 4, 2024, the disclosure of which is incorporated by reference herein in its entirety.

### TECHNICAL FIELD

The present invention relates to a key structure, and in particular relates to a key structure with both touch and backlight functions.

### BACKGROUND

Traditional keyboard keys (e.g., space bar) only provide a single pressing input function and fail to meet the modern user's demand for multifunctional operations. With the rapid development of electronic devices and human-computer interaction technologies, users now have more requirements for keyboard keys, expecting a single key to perform more functions.

In light of this, addressing how to meet the user's requirements for keyboard keys has become a key area of focus for those skilled in the art.

### SUMMARY

According to one aspect of the present invention, a key structure is provided. The key structure comprises a circuit board, at least one light-emitting unit, a light guide plate and a keycap. The circuit board has a touch-sensing circuit. The at least one light-emitting unit is electrically connected to the circuit board and positioned above the circuit board. The light guide plate is positioned adjacent to the at least one light-emitting unit and above the circuit board. The keycap is positioned above the at least one light-emitting unit, the light guide plate, and the circuit board.

The above summary is not intended to represent all embodiments or all aspects of the present invention. Rather, the foregoing summary merely provides examples that illustrate the novel aspects and features of the present invention. The above and other aspects of the present invention will become better understood with regard to the following detailed description of the preferred but non-limiting embodiment(s). The following description is made with reference to the accompanying drawings.

### BRIEF DESCRIPTION OF THE DRAWINGS

The following figures are merely illustrative of embodiments and are not intended to limit the scope of embodiments or claims.

FIG. 1 is a layered structure diagram of a key structure according to one embodiment of the present invention.

FIG. 2 is a layered structure diagram of a key structure according to another embodiment of the present invention.

FIG. 3 is a layered structure diagram of a key structure according to another embodiment of the present invention.

FIG. 4 is a layered structure diagram of a key structure according to another embodiment of the present invention.

FIG. 5 is a schematic diagram showing that the key structure of FIG. 1 is applied to a keyboard base plate.

FIG. 6 is a schematic diagram showing that the key structure of FIG. 1 is applied to a keyboard base plate.

### DETAILED DESCRIPTION

Detailed descriptions of the embodiments of the specification are disclosed below with reference to the accompanying drawings. Apart from the detailed descriptions provided, any embodiments in which the present invention can be used as well as any substitutions, modifications or equivalent changes of the said embodiments are within the scope of the disclosure, and the descriptions and definitions in the claims shall prevail. In the following detailed description, for purposes of explanation, numerous specific details are set forth in order to provide a thorough understanding of the disclosed embodiments. It will be apparent, however, that one or more embodiments may be practiced without these specific details. Additionally, well-known common steps or components are not described in detail to avoid unnecessarily limiting the present invention. The same or similar elements in the figures are represented by the same or similar symbols. Please note that the illustrations are for schematic purposes only and do not represent the actual size or quantity of the components, unless otherwise specified.

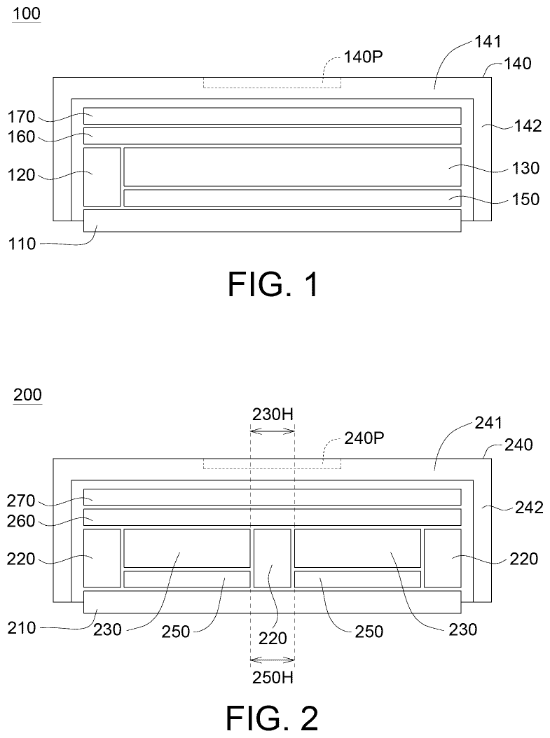

Please refer to FIG. 1, which illustrates the layered structure diagram of the key structure 100 according to one embodiment of the present invention.

The key structure 100 may, but not limited to, be a space bar of a keyboard device. The key structure 100 comprises a circuit board 110, a light-emitting unit 120, a light guide plate 130, and a keycap 140. For example, the circuit board 110 is a printed circuit board (PCB). The circuit board 110 may have a touch-sensing circuit (not shown), enabling the key structure 100 to have the touch function (e.g., for user sliding operations), which distinguishes it from a conventional space bar design. For example, the touch-sensing circuit may be a capacitive touch-sensing circuit. For example, the light-emitting unit 120 is a light-emitting diode (LED). The light-emitting unit 120 is electrically connected to the circuit board 110 and is positioned above the circuit board 110. For example, the light-emitting unit 120 can be mounted on the circuit board 110 by using the surface mount technology (SMT). Specifically, the circuit board 110 may have a backlight driving circuit to drive the light-emitting unit 120 for light emission, thereby providing the key structure 100 with backlight function. The backlight driving circuit and the touch-sensing circuit can be integrated on a printed circuit board as the circuit board 110. The light guide plate 130 is positioned adjacent to the light-emitting unit 120 and above the circuit board 110. The light guide plate 130 has optical microstructures for converting the lateral light emission from a point light source of the light-emitting unit 120 into the upward light emission of a surface light source, thereby improving backlight uniformity.

For example, the keycap 140 is a plastic keycap. The keycap 140 is positioned above the light-emitting unit 120, the light guide plate 130, and the circuit board 110. In the example where the key structure 100 is a space bar, the keycap 140 is an elongated keycap corresponding to a multi-size key. The top surface of the keycap 140 may have a translucent symbol area 140P. The translucent symbol area 140P may be designed with hidden characters or patterns. That is, when no light is emitted from the light-emitting unit 120, the translucent symbol area 140P is invisible on the top surface of the keycap 140. When light is emitted from the light-emitting unit 120, the translucent symbol area 140P becomes visible on the top surface of the keycap 140 to display characters or patterns.

The key structure 100 may further include a reflective sheet 150, a diffusion plate 160, and a light-transmitting film 170. The reflective sheet 150 is positioned adjacent to the light-emitting unit 120, and further positioned between the light guide plate 130 and the circuit board 110. The reflective sheet 150 may be configured to reflect the light emitted from the bottom of the light guide plate 130 back into the light guide plate 130 to redirect the light toward the keycap 140, thereby reducing light loss. The diffusion plate 160 is positioned above the light-emitting unit 120 and the light guide plate 130, and further positioned between the keycap 140 and the light guide plate 130. The diffusion plate 160 may be configured to cause the light emitted from the top of the light guide plate 130 to penetrate and scatter, achieving the effect of uniform light distribution for the upward light emission. For example, the light-transmitting film 170 is a semi-transparent film made of polyethylene terephthalate (PET). The light-transmitting film 170 is positioned between the keycap 140 and the light guide plate 130 as well as the light-emitting unit 120. The light-transmitting film 170 may be configured to further disperse the light that penetrates through the diffusion plate 160, making the backlight effect under the keycap 140 more uniform.

In addition, the keycap 140 may have a top portion 141 and a side extending portion 142. The side extending portion 142 extends downward from the edge of the top portion 141. In this embodiment, the side extending portion 142 covers side edges of the circuit board 110, the light-emitting unit 120, the light guide plate 130, the reflective sheet 150, the diffusion plate 160, and the light-transmitting film 170.

Please refer to FIG. 2, which illustrates the layered structure diagram of the key structure 200 according to one embodiment of the present invention.

The key structure 200 may, but not limited to, be a space bar of a keyboard device. The key structure 200 comprises a circuit board 210, a light-emitting unit 220, a light guide plate 230, and a keycap 240. For example, the circuit board 210 is a printed circuit board. The circuit board 210 may have a touch-sensing circuit (not shown), enabling the key structure 200 to have the touch function (e.g., for user sliding operations), which distinguishes it from a conventional space bar design. For example, the touch-sensing circuit may be a capacitive touch-sensing circuit. For example, the light-emitting unit 220 is a light-emitting diode. The key structure 200 comprises a plurality of light-emitting units 220 (taking three light-emitting units as an example in this embodiment, but not limited thereto), and these light-emitting units 220 are spaced apart below the keycap 240. The light-emitting unit 220 is electrically connected to the circuit board 210 and is positioned above the circuit board 210. For example, the light-emitting unit 220 can be mounted on the circuit board 210 by using the surface mount technology. Specifically, the circuit board 210 may have a backlight driving circuit to drive the light-emitting unit 220 for light emission, thereby providing the key structure 200 with backlight function. The backlight driving circuit and the touch-sensing circuit can be integrated on a printed circuit board such as the circuit board 210.

The light guide plate 230 is positioned adjacent to the light-emitting unit 220 and above the circuit board 210. Specifically, the light guide plate 230 is positioned between two adjacent light-emitting units 220. In this embodiment, the light guide plate 230 has a light guide plate hole 230H, and the middle light-emitting unit 220 is positioned within the light guide plate hole 230H. In other embodiments, a plurality of light guide plates 230 may be used instead of perforating the light guide plate 230. In such embodiments, a single light guide plate 230 is provided between two adjacent light-emitting units 220, and the plurality of light guide plates 230 are spaced apart above the circuit board 210. The light guide plate 230 has optical microstructures for converting the lateral light emission from a point light source of the light-emitting unit 220 into the upward light emission of a surface light source, thereby improving backlight uniformity.

For example, the keycap 240 is a plastic keycap. The keycap 240 is positioned above the light-emitting unit 220, the light guide plate 230, and the circuit board 210. In the example where the key structure 200 is a space bar, the keycap 240 is an elongated keycap corresponding to a multi-size key. The top surface of the keycap 240 may have a translucent symbol area 240P. The translucent symbol area 240P may be designed with hidden characters or patterns. That is, when no light is emitted from the light-emitting unit 220, the translucent symbol area 240P is invisible on the top surface of the keycap 240. When light is emitted from the light-emitting unit 220, the translucent symbol area 240P becomes visible on the top surface of the keycap 240 to display characters or patterns.

The key structure 200 may further include a reflective sheet 250, a diffusion plate 260, and a light-transmitting film 270. The reflective sheet 250 is positioned adjacent to the light-emitting unit 220, and further positioned between the light guide plate 230 and the circuit board 210. Specifically, the reflective sheet 250 is positioned between two adjacent light-emitting units 220. In this embodiment, the reflective sheet 250 has a reflective sheet hole 250H, and the middle light-emitting unit 220 is positioned within the reflective sheet hole 250H. The reflective sheet hole 250H can be aligned with the aforementioned light guide plate hole 230H. In other embodiments, a plurality of reflective sheets 250 may be used instead of perforating the reflective sheet 250. In such embodiments, a single reflective sheet 250 is provided between two adjacent light-emitting units 220, and the plurality of reflective sheets 250 are spaced apart between the light guide plate 230 and the circuit board 210. The reflective sheet 250 may be configured to reflect the light emitted from the bottom of the light guide plate 230 back into the light guide plate 230 to redirect the light toward the keycap 240, thereby reducing light loss.

The diffusion plate 260 is positioned above the light-emitting unit 220 and the light guide plate 230, and further positioned between the keycap 240 and the light guide plate 230. The diffusion plate 260 may be configured to cause the light emitted from the top of the light guide plate 230 to penetrate and scatter, achieving the effect of uniform light distribution for the upward light emission. For example, the light-transmitting film 270 is a semi-transparent film made of polyethylene terephthalate. The light-transmitting film 270 is positioned between the keycap 240 and the light guide plate 230 as well as the light-emitting unit 220. The light-transmitting film 270 may be configured to further disperse the light that penetrates through the diffusion plate 260, making the backlight effect under the keycap 240 more uniform.

In addition, the keycap 240 may have a top portion 241 and a side extending portion 242. The side extending portion 242 extends downward from the edge of the top portion 241. In this embodiment, the side extending portion 242 covers side edges of the circuit board 210, the two light-emitting units 220 at two sides, the diffusion plate 260, and the light-transmitting film 270.

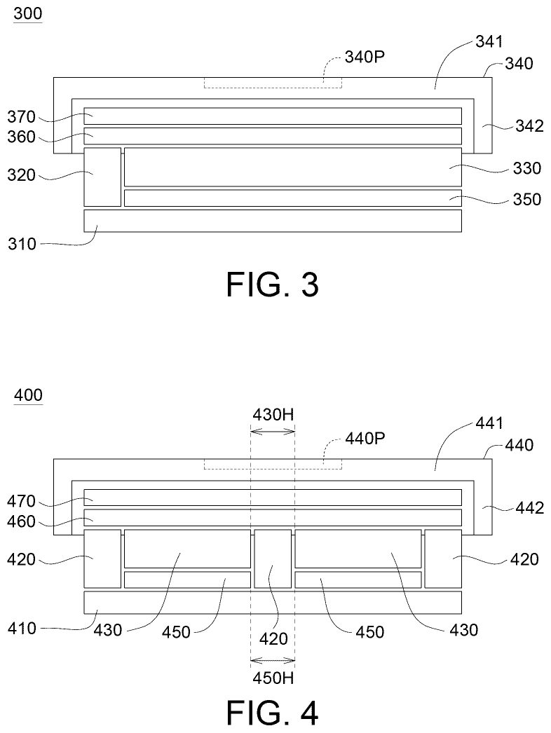

Please refer to FIG. 3, which illustrates the layered structure diagram of the key structure 300 according to another embodiment of the present invention.

The key structure 300 may, but not limited to, be a space bar of a keyboard device. The key structure 300 comprises a circuit board 310, a light-emitting unit 320, a light guide plate 330, and a keycap 340. For example, the circuit board 310 is a printed circuit board. The circuit board 310 may have a touch-sensing circuit (not shown), enabling the key structure 300 to have the touch function (e.g., for user sliding operations), which distinguishes it from a conventional space bar design. For example, the touch-sensing circuit may be a capacitive touch-sensing circuit. For example, the light-emitting unit 320 is a light-emitting diode. The light-emitting unit 320 is electrically connected to the circuit board 310 and is positioned above the circuit board 310. For example, the light-emitting unit 320 can be mounted on the circuit board 310 by using the surface mount technology. Specifically, the circuit board 310 may have a backlight driving circuit to drive the light-emitting unit 320 for light emission, thereby providing the key structure 300 with backlight function. The backlight driving circuit and the touch-sensing circuit can be integrated on a printed circuit board such as the circuit board 310. The light guide plate 330 is positioned adjacent to the light-emitting unit 320 and above the circuit board 310. The light guide plate 330 has optical microstructures for converting the lateral light emission from a point light source of the light-emitting unit 320 into the upward light emission of a surface light source, thereby improving backlight uniformity.

For example, the keycap 340 is a plastic keycap. The keycap 340 is positioned above the light-emitting unit 320, the light guide plate 330, and the circuit board 310. In the example where the key structure 300 is a space bar, the keycap 340 is an elongated keycap corresponding to a multi-size key. The top surface of the keycap 340 may have a translucent symbol area 340P. The translucent symbol area 340P may be designed with hidden characters or patterns. That is, when no light is emitted from the light-emitting unit 320, the translucent symbol area 340P becomes invisible on the top surface of the keycap 340. When light is emitted from the light-emitting unit 320, the translucent symbol area 340P is visible on the top surface of the keycap 340 to display characters or patterns.

The key structure 300 may further include a reflective sheet 350, a diffusion plate 360, and a light-transmitting film 370. The reflective sheet 350 is positioned adjacent to the light-emitting unit 320, and further positioned between the light guide plate 330 and the circuit board 310. The reflective sheet 350 may be configured to reflect the light emitted from the bottom of the light guide plate 330 back into the light guide plate 330 to redirect the light toward the keycap 340, thereby reducing light loss. The diffusion plate 360 is positioned above the light-emitting unit 320 and the light guide plate 330, and further positioned between the keycap 340 and the light guide plate 330. The diffusion plate 360 may be configured to cause the light emitted from the top of the light guide plate 330 to penetrate and scatter, achieving the effect of uniform light distribution for the upward light emission. For example, the light-transmitting film 370 is a semi-transparent film made of polyethylene terephthalate. The light-transmitting film 370 is positioned between the keycap 340 and the light guide plate 330 as well as the light-emitting unit 320. The light-transmitting film 370 may be configured to further disperse the light that penetrates through the diffusion plate 360, making the backlight effect under the keycap 340 more uniform.

In addition, the keycap 340 may have a top portion 341 and a side extending portion 342. The side extending portion 342 extends downward from the edge of the top portion 341. In this embodiment, the side extending portion 342 exposes side edges of the circuit board 310, the light-emitting unit 320, the light guide plate 330, the reflective sheet 350, the diffusion plate 360, and the light-transmitting film 370. In other words, the extension length of the side extending portion 342 in this embodiment is shorter than the extension lengths of the side extending portions 142 and 242 in the previous embodiments. This indicates that the size of the side extending portion of the keycap can be adjusted and designed as required for implementation.

Please refer to FIG. 4, which illustrates the layered structure diagram of the key structure 400 according to one embodiment of the present invention.

The key structure 400 may, but not limited to, be a space bar of a keyboard device. The key structure 400 comprises a circuit board 410, a light-emitting unit 420, a light guide plate 430, and a keycap 440. For example, the circuit board 410 is a printed circuit board. The circuit board 410 may have a touch-sensing circuit (not shown), enabling the key structure 400 to have the touch function (e.g., for user sliding operations), which distinguishes it from a conventional space bar design. For example, the touch-sensing circuit may be a capacitive touch-sensing circuit. For example, the light-emitting unit 420 is a light-emitting diode. The key structure 400 comprises a plurality of light-emitting units 420 (taking three light-emitting units as an example in this embodiment, but not limited thereto), and these light-emitting units 420 are spaced apart below the keycap 440. The light-emitting unit 420 is electrically connected to the circuit board 410 and is positioned above the circuit board 410. For example, the light-emitting unit 420 can be mounted on the circuit board 410 by using the surface mount technology. Specifically, the circuit board 410 may have a backlight driving circuit to drive the light-emitting unit 420 for light emission, thereby providing the key structure 400 with backlight function. The backlight driving circuit and the touch-sensing circuit can be integrated on a printed circuit board such as the circuit board 410.

The light guide plate 430 is positioned adjacent to the light-emitting unit 420 and above the circuit board 410. Specifically, the light guide plate 430 is positioned between two adjacent light-emitting units 420. In this embodiment, the light guide plate 430 has a light guide plate hole 430H, and the middle light-emitting unit 420 is positioned within the light guide plate hole 430H. In other embodiments, a plurality of light guide plates 430 may be used instead of perforating the light guide plate 430. In such embodiments, a single light guide plate 430 is provided between two adjacent light-emitting units 420, and the plurality of light guide plates 430 are spaced apart above the circuit board 410. The light guide plate 430 has optical microstructures for converting the lateral light emission from a point light source of the light-emitting unit 420 into the upward light emission of a surface light source, thereby improving backlight uniformity.

For example, the keycap 440 is a plastic keycap. The keycap 440 is positioned above the light-emitting unit 420, the light guide plate 430, and the circuit board 410. In the example where the key structure 400 is a space bar, the keycap 440 is an elongated keycap corresponding to a multi-size key. The top surface of the keycap 440 may have a translucent symbol area 440P. The translucent symbol area 440P may be designed with hidden characters or patterns. That is, when no light is emitted from the light-emitting unit 420, the translucent symbol area 440P is invisible on the top surface of the keycap 440. When light is emitted from the light-emitting unit 420, the translucent symbol area 440P becomes visible on the top surface of the keycap 440 to display characters or patterns.

The key structure 400 may further include a reflective sheet 450, a diffusion plate 460, and a light-transmitting film 470. The reflective sheet 450 is positioned adjacent to the light-emitting unit 420, and further positioned between the light guide plate 430 and the circuit board 410. Specifically, the reflective sheet 450 is positioned between two adjacent light-emitting units 420. In this embodiment, the reflective sheet 450 has a reflective sheet hole 450H, and the middle light-emitting unit 420 is positioned within the reflective sheet hole 450H. The reflective sheet hole 450H can be aligned with the aforementioned light guide plate hole 430H. In other embodiments, a plurality of reflective sheets 450 may be used instead of perforating the reflective sheet 450. In such embodiments, a single reflective sheet 450 is provided between two adjacent light-emitting units 420, and the plurality of reflective sheets 450 are spaced apart between the light guide plate 430 and the circuit board 410. The reflective sheet 450 may be configured to reflect the light emitted from the bottom of the light guide plate 430 back into the light guide plate 430 to redirect the light toward the keycap 440, thereby reducing light loss.

The diffusion plate 460 is positioned above the light-emitting unit 420 and the light guide plate 430, and further positioned between the keycap 440 and the light guide plate 430. The diffusion plate 460 may be configured to cause the light emitted from the top of the light guide plate 430 to penetrate and scatter, achieving the effect of uniform light distribution for the upward light emission. For example, the light-transmitting film 470 is a semi-transparent film made of polyethylene terephthalate. The light-transmitting film 470 is positioned between the keycap 440 and the light guide plate 430 as well as the light-emitting unit 420. The light-transmitting film 470 may be configured to further disperse the light that penetrates through the diffusion plate 460, making the backlight effect under the keycap 440 more uniform.

In addition, the keycap 440 may have a top portion 441 and a side extending portion 442. The side extending portion 442 extends downward from the edge of the top portion 441. In this embodiment, the side extending portion 442 exposes side edges of the circuit board 410 and the two light-emitting units 420 at two sides. In other words, the extension length of the side extending portion 442 in this embodiment is shorter than the extension lengths of the side extending portions 142 and 242 in the previous embodiments. This indicates that the size of the side extending portion of the keycap can be adjusted and designed as required for implementation.

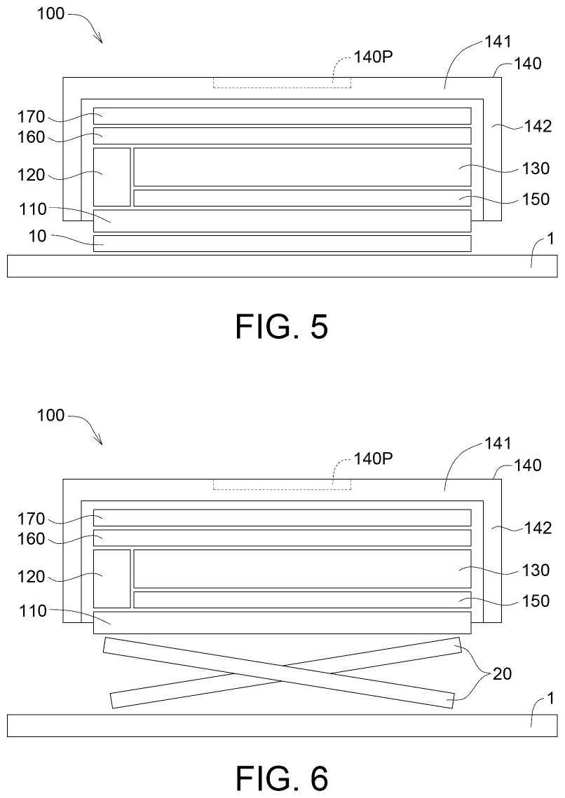

Please refer to FIG. 5, which illustrates a schematic diagram showing that the key structure 100 of FIG. 1 is applied to a keyboard base plate 1.

The key structure 100 can function as a key for a keyboard device, with the keyboard base plate 1 being part of the keyboard device. The key structure 100 may be connected to the keyboard base plate 1 through a piezoelectric sensing module 10. The piezoelectric sensing module 10 is electrically connected to the circuit board 110 of the key structure 100 and positioned below the circuit board 110. Specifically, the circuit board 110 may be electrically connected to the piezoelectric sensing module 10 via a conductive cable. When the user presses the key structure 100, the mechanical energy generated can be converted into electrical energy by the piezoelectric sensing module 10. The corresponding electrical signal is transmitted to the switch circuit board of the keyboard device (e.g., a membrane circuit board), enabling the input function of the key. Furthermore, when the user presses the key structure 100, the piezoelectric sensing module 10 can detect the corresponding pressure intensity and convert it into a driving signal. This driving signal activates an actuator within the piezoelectric sensing module 10 to produce vibrations, providing tactile feedback to the user. FIG. 5 illustrates the key structure 100 as an example, but the present invention is not limited thereto. It should be understood that the key structure 100 can be replaced with the aforementioned key structures 200, 300, or 400 for implementation.

FIG. 6 illustrates a schematic diagram showing that the key structure of FIG. 1 is applied to a keyboard base plate.

The key structure 100 can function as a key for a keyboard device, with the keyboard base plate 1 being part of the keyboard device. The key structure 100 can be connected to the keyboard base plate 1 through a lift component 20, enabling the key structure 100 to move reciprocally relative to the keyboard base plate 1. Specifically, the lift component 20 may be a scissor mechanism. When the user presses the key structure 100, the lift component 20 allows the key structure 100 to move downward to be in contact with the switch circuit board (e.g., a membrane circuit board), thereby achieving the input function of the key. FIG. 6 illustrates the key structure 100 as an example, but the present invention is not limited thereto. It should be understood that the key structure 100 can be replaced with the aforementioned key structures 200, 300, or 400 for implementation.

Based on the above descriptions, the present invention discloses a novel key structure. By the circuit board with the touch-sensing circuit, the light-emitting unit and the light guide plate, a single key can achieve both touch and backlight functions. Also, the keycap of the key structure retains its function of allowing the user to press for input. Additionally, when the key structure is further disposed on a keyboard device via a piezoelectric sensing module, it can provide tactile feedback to the user. Therefore, the key structure proposed in this disclosure can achieve more functional operations compared to conventional keyboard keys.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A key structure, comprising:
a circuit board having a touch-sensing circuit;
at least one light-emitting unit electrically connected to the circuit board and positioned above the circuit board;
a light guide plate positioned adjacent to the at least one light-emitting unit and above the circuit board; and
a keycap positioned above the at least one light-emitting unit, the light guide plate, and the circuit board.

2. The key structure according to claim 1, further comprising:
a reflective sheet positioned adjacent to the at least one light-emitting unit and between the light guide plate and the circuit board.

3. The key structure according to claim 1, further comprising:
a diffusion plate positioned above the at least one light-emitting unit and the light guide plate.

4. The key structure according to claim 1, further comprising:
a light-transmitting film positioned between the keycap and the light guide plate as well as the at least one light-emitting unit.

5. The key structure according to claim 1, wherein the key structure is connected to a keyboard base plate through a piezoelectric sensing module, and the piezoelectric sensing module is electrically connected to the circuit board and positioned below the circuit board.

6. The key structure according to claim 1, wherein the key structure is connected to the keyboard base plate through a lift component, and the key structure is movable reciprocally relative to the keyboard base plate.

7. The key structure according to claim 1, wherein the at least one light-emitting unit is a plurality of light-emitting units, and the light-emitting units are spaced apart below the keycap.

8. The key structure according to claim 7, wherein the light guide plate is positioned between two adjacent light-emitting units.

9. The key structure according to claim 7, wherein the light guide plate has a light guide plate hole, and one of the light-emitting units is positioned within the light guide plate hole.

10. The key structure according to claim 7, further comprising:
a reflective sheet positioned between two of the light-emitting units being adjacent, wherein the reflective sheet is positioned below the keycap, the reflective sheet has a reflective sheet hole, and one of the light-emitting units is positioned within the reflective sheet hole.

11. The key structure according to claim 1, wherein the keycap has a side extending portion, the side extending portion covers side edges of the at least one light-emitting unit, the light guide plate, and the circuit board.

12. The key structure according to claim 1, wherein the keycap has a side extending portion, the side extending portion exposes side edges of the at least one light-emitting unit, the light guide plate, and the circuit board.

13. The key structure according to claim 1, wherein a translucent symbol area is provided on a top surface of the keycap, when no light is emitted from the at least one light-emitting unit, the translucent symbol area is invisible on the top surface of the keycap.

14. The key structure according to claim 1, wherein a translucent symbol area is provided on a top surface of the keycap, when light is emitted from the at least one light-emitting unit, the translucent symbol area is visible on the top surface of the keycap.

15. The key structure according to claim 1, further comprising:
a reflective sheet for reflecting light from the bottom of the light guide plate back into the light guide plate to redirect the light toward the keycap.
